(19) United States
(12) Patent Application Publication
(10) Pub. No.: US 2006/0053035 A1
(43) Pub. Date: Mar. 9, 2006

(54) Healthcare personnel management system

(76) Inventor: Floyd P. Eisenberg, Ambler, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/065,551

(22) Filed: Feb. 24, 2005

Related U.S. Application Data
(60) Provisional application No. 60/608,452, filed on Sep. 9, 2004.

(51) Int. Cl. G06Q 10/00

(52) U.S. Cl. 705/2

(57) ABSTRACT

A system manages load-balancing of assignment of tasks to healthcare workers. The system assigns patient treatment related tasks to healthcare workers using an interface processor for receiving information identifying treatment services required to be delivered to a patient. A worker assignment processor, in response to the information identifying the treatment services, automatically identifies at least one healthcare worker to provide the services to the patient based on data indicating, worker credentials, worker privilege status, and worker availability. A communication processor initiates generation of an alert message to an identified worker notifying the identified worker of an assignment.

This is a non-provisional application of provisional application Ser. No. 60/608,452 by F. P. Eisenberg et al. filed Sep. 9, 2004.

### FIELD OF THE INVENTION

This invention concerns a system and user interface for use in assigning patient treatment related tasks to healthcare workers.

### BACKGROUND INFORMATION

In existing systems, work task load-balancing of healthcare workers, if it occurs at all, is typically a manual management of human resources and fails to coordinate task workflow among the most capable clinicians to deliver the best results in patient care. The Manual management employed by existing systems leads to errors in assumptions regarding competence and capabilities and potential medical-legal risk due to misalignment of tasks with clinical competencies. It also incurs significant delays in throughput as non-privileged clinicians are assigned tasks which subsequently need to be re-assigned and overloaded clinicians are assigned additional tasks beyond their capabilities. The result is a potentially significant compromise to quality of care due to delays in work task performance. A system according to invention principles addresses these deficiencies and related problems.

### SUMMARY OF THE INVENTION

A system provides managed load-balancing of assignment of tasks to healthcare workers based on worker (e.g., clinician) privileges, availability and competencies derived from worker profiles and avoids re-assignment and potential backlogs due to overload or competency issues. A system assigns patient treatment related tasks to healthcare workers using an interface processor for receiving information identifying treatment services required to be delivered to a patient. A worker assignment processor, in response to the information identifying the treatment services, automatically identifies at least one healthcare worker to provide the services to the patient based on data indicating, worker credentials, worker privilege status, and worker availability. A communication processor initiates generation of an alert message to an identified worker notifying the identified worker of an assignment.

### BRIEF DESCRIPTION OF THE DRAWING

FIG. 1 shows a system for automated task assignment and clinical load balancing, according to invention principles.

FIG. 2 shows a networked hospital information system employing automated task assignment and clinical load balancing, according to invention principles.

FIG. 3 shows a process for automated task assignment and clinical load balancing, according to invention principles.

FIG. 4 shows a process for determining services required by a patient, according to invention principles.

FIG. 5 shows a process for determining clinician availability and suitability for delivering services required by a patient, according to invention principles.

FIG. 6 shows a flowchart of a process for automated task assignment and clinical load balancing, according to invention principles.

### DETAILED DESCRIPTION OF INVENTION

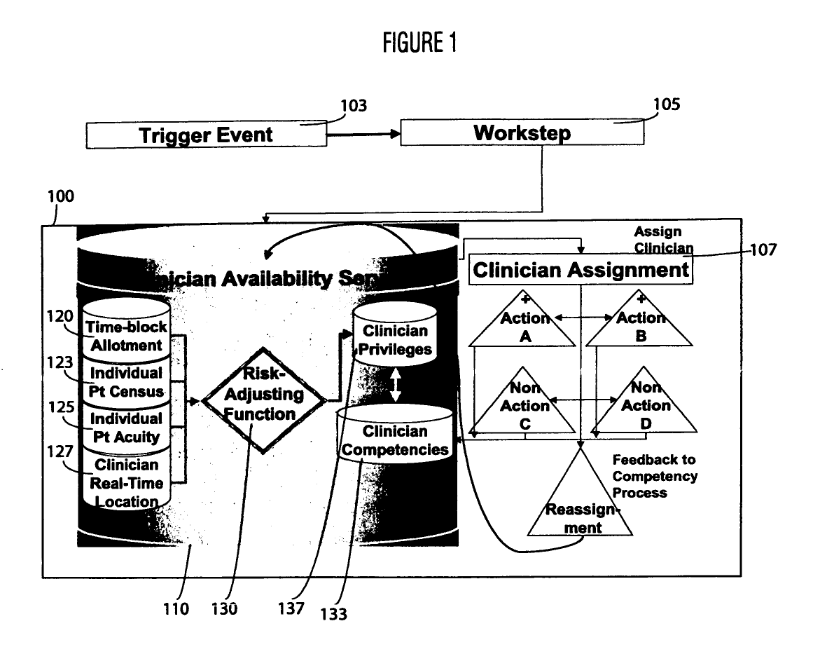

FIG. 1 shows a system for automated task assignment and clinical load balancing. The system provides managed load-balancing of assignment of tasks to healthcare workers based on worker (e.g., clinician) privileges, availability and competencies derived from worker profiles and avoids re-assignment and potential backlogs due to overload or competency issues. The system improves the efficiency of patient care delivery and decreases medical-legal risks by improving alignment of task assignments with clinical competencies. The efficiency of patient care delivery is also increased by system avoidance of task re-assignment resulting from subsequent determination of an absence of appropriate clinical privilege and by improved balancing of task assignments among available workers. The system improves the quality of care and decreases clinical care adverse outcomes or complications due to delays in care delivery processes.

Clinical care processes require coordination of activities among multiple clinicians and technical human resources. Tracking mechanisms for scheduling, resource management and online availability are able to manage technical and durable goods and resources. However, human resource availability tracking is more problematic. While scheduling software can identify blocks of time specifically devoted to types of activities, multiple simultaneous demands on clinician time are difficult to prioritize. Worker, availability needs to be determined based on multiple factors: (a) time block allotment, (b) workload (patient and task load), (c) patient acuity risk, and (d) location. Further, to appropriately assign a clinician for a workstep (task), however, also requires knowledge that the individual has privileges to perform an activity. A credential database and/or human resource information provides generic training and certification attributes of an individual. Computer system security privileges are generally based on credential and/or assignment-based human resource categories (e.g., “physician,” “nurse, geographically or specialty assigned”, “respiratory therapist,” etc.).

In existing systems, privilege information is typically acquired and updated based on performance tracking of an individual healthcare worker. Individual healthcare worker performance is quantified based on number and quality of services provided, for example. Further, when privileging information is electronically coordinated with performance monitoring in existing systems, it is not employed in real-time clinical task selection or assignment. In contrast, the system advantageously enables the creation of an assignment of a clinical work task for performance by a worker based on real-time worker availability information (calculated according to multiple criteria) and clinical privilege information. Therefore, task assignment is made to the most appropriate, privileged and available clinician, avoiding delays in care delivery. The system employs clinical privilege information and documented experience information derived from a variety of sources to provide an experience based learning capability for a healthcare provider organization information system.

An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

The system provides managed load-balancing of assignment of tasks to healthcare workers using multiple components. In existing systems, these components are managed in non-co-operative separate, disparate systems and some of the components may be managed with manual paper processes. In the system described herein these components include workstep processes. A workstep is an action or task required to be performed by a healthcare worker as part of a care delivery process flow. A workstep requires an actor (a specified type of individual expected to perform the workstep that has specific privileges required of the individual to accomplish the task) and an outcome (the result of completing the action, successfully or unsuccessfully or, in the absence of an action, a “nil” result). The system uses reproducible terminology to identify a workstep that requires management, a type of individual actor expected to perform the workstep, and the outcomes expected. Data identifying a workstep is incorporated into a process managed by a workflow engine. Alternatively, data identifying a workstep is generated in response to entry of related information such as treatment order information, specific documentation elements, test results, etc.

Worker availability information comprises another component employed by the load-balancing task assignment system. The availability of an individual worker is determined from criteria including, (a) available time block allotment, (b) least eventful workload (patient load), (c) patient-mix of acuity (medical condition severity) risk used to adjust a numerical patient load factor, and (d) worker proximate location. The system determines worker availability and prioritizes scheduling of workstep (task) performance based on individual patient acuity and need and the availability criteria.

Clinician privilege information comprises another component employed by the load-balancing task assignment system. Clinical privilege information identifies capabilities of individual clinicians based on successful treatment experience of an individual identified task in a healthcare provider organization or based on documented experience information received from external sources (e.g., other healthcare provider organizations). An individual is not permitted to practice within a healthcare provider organization without meeting basic credential requirements. Clinician privilege information of this system is advantageously more detailed than a credential data set used in existing systems. Credential information used by existing systems identifies generic training and certification attributes of an individual (physician and non-physician). Existing privilege verification systems vary by type of organization and are frequently haphazard in operation, relying on the honor system (that clinicians perform only those tasks for which they have privileges) or rely on the memory and knowledge of colleagues and clinical managers. In such existing systems, privilege determination and verification is typically performed and updated based on performance tracking of an individual worker (e.g., monitoring of the number and quality of tasks performed).

Clinical competency information comprises another component employed by the load-balancing task assignment system. Clinical competency as defined by the Office of Human Resource Management (OHRM), Clinical Center, National Institutes of Health, US Department of Health and Human Services, 15 Nov. 2001, for example, comprises “the thoughtful integration of one's knowledge, skills and abilities in order to perform effectively on the job. Competencies are observable and measurable behaviors which are critical to successful individual and corporate performance”. Both the measurement and competency of clinicians in healthcare delivery organizations is variable. Increasingly, organizations are measuring a frequency with which each clinician performs specified tasks or procedures, although some rely on voluntary reporting by clinicians. Further, clinical success outcome indicators are variably applied by organizations.

The load-balancing task assignment system acquires and monitors competency data and aggregates and analyzes the acquired competency data to determine a competency and performance categorization of clinicians. The competency data is derived from a clinical information system and includes the frequency with which a healthcare worker performs or manages specified tasks, processes and procedures and associated clinical success outcome indicators and other factors.

A further component employed by the load-balancing task assignment system is a notification function. The notification function notifies a healthcare worker of a scheduled task (workstep) in a manner consistent with an expected priority of task completion and tracks responses for continuous competency management. A communicated assignment notification includes actionable response suggestions and potential reasons for non-action. The notification function also provides a healthcare worker with an ability to refuse a task assignment and request a task reassignment.

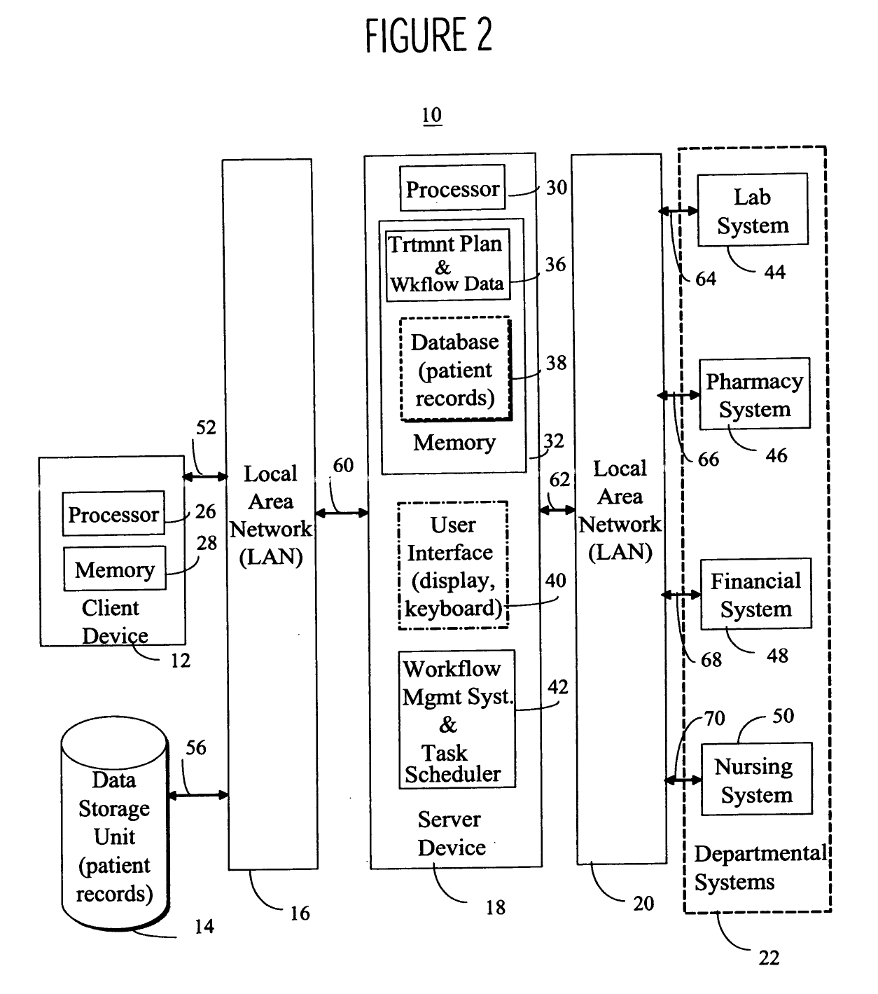

FIG. 1 shows a system for automated task assignment and clinical load balancing. A workstep process function 105 generates data indicating expected (or recommended) actions to be performed by a healthcare worker (e.g., a clinician) in response to a clinical trigger event 103. Clinical trigger event 103 may comprise an order for a patient treatment, a documentation data element entry (or observation), entry of patient test result data (generally via an interface from a device or ancillary system), or a workflow engine sub-process. A configuration processor in application 42 (Workflow Management System, FIG. 2) enables a user to enter data identifying types of permitted clinical trigger event 103. The entered clinical trigger event identification data identifies a clinical problem (e.g., on a problem list), a diagnosis on a diagnosis list, or another data element for use in workstep management. Workstep function 105 generates data representing expected (or recommended) actions or decisions based on a modeled ontology or based on predetermined work effort coordination (e.g., clinical protocol or a guideline requiring a decision to be made by a clinician). Workstep function 105 also generates ancillary data that provides information regarding a type of clinician and privileges and experience required to accomplish the expected (or recommended) actions or make expected decisions. Alternatively, workstep function 105 accesses application 100 on server 110 to determine a type of clinician and associated privileges required to perform the expected task or to make the expected decisions.

Workstep function 105 accesses application 100 on server 110 to determine in real-time, available clinicians with the required privileges and competencies. Application 100 uses risk-adjusting function 130 to process clinical privilege information derived from repository 137 and competency information derived from repository 133 to identify, sort and rank clinicians by availability and competency. Specifically, function 130 of application 100 provides data indicating available clinicians and associated probabilities. A probability associated with an individual clinician indicates a probability the individual clinician possesses the capability of performing a particular task in an expected time frame. Risk-adjusting function 130 provides data indicating available clinicians and associated probabilities based on factors including available time blocks 120 of individual clinicians, patient census and load 123 of individual clinicians, patient acuity (severity of patient medical condition) 125 and locations of clinicians 127. Function 130 coordinates patient treatment urgency and priority, with clinician privileges and competencies in providing data indicating available clinicians and associated probabilities. The system thereby improves staffing allocation and prediction of staffing ratios required for near-term assignments (e.g., next shift of nursing assignments). Application 100 is configurable by a user to automatically assign the most available clinician to perform a particular task or to communicate data indicating available clinicians and associated probabilities to a worker (such as a nursing manager or a medical director) to manually choose an appropriate clinician.

Unit 107 of application 100 automatically assigns the most available clinician to perform a particular task and notifies the clinician by a method selected in accordance with the priority of a particular task. The configuration processor in application 100 enables a user to enter data associating individual healthcare workers with notification methods (such as mail, pager, email, phone) ranked according to task priority and compatible with an information system architecture. The notified clinician is provided by unit 107 with actionable information and takes one of the suggested actions (e.g., action A or B) or determines not to act and provides a reason (e.g., reason C or D). Alternatively, the notified clinician requests the particular task be re-assigned. In response to a clinician request to re-assign the particular task, application 100 reassigns the particular task using risk-adjusting function 130 and clinical privilege and competency information repositories 137 and 133 respectively. For this purpose function 130 sorts and ranks clinicians (excluding the clinician initiating the re-assignment request unless there is no alternate competent clinician) by availability and competency. In the case, that there is no alternate competent clinician to the clinician initiating the re-assignment request, this clinician is notified that there is no alternative. Application 100 also monitors performance of tasks by assigned clinicians and stores monitoring data (including the number and type of procedures performed and corresponding outcomes and associated data) in competency information repository 133.

Application 100 automates task assignment using load-balancing such that the most available clinician is notified to perform a requested task. Application 100 also provides automated performance monitoring using competency repository 133 that stores monitoring data including the number and type of procedures performed and corresponding outcomes. Application 100 uses information in competency repository 133 in updating clinical privilege information in repository 137 as well as for management reporting, human resource clinician performance management and clinical outcome reporting. The system is usable in real-time processes for re-direction of tasks and is of particular use within clinical care settings to coordinate the effectiveness and efficiency of human resources to improve throughput. In contrast, in existing systems, staff assignment, especially in nursing, is typically based on patient acuity and not on the tasks and processes required to manage such patients and fail to coordinate tasks and provide load balancing. Existing systems typically do not apply data mining and prediction software within a workflow process. Further, such data mining and prediction software lacks sufficient granularity to re-direct processes in real-time to avoid roadblocks in care delivery and improve throughput.

The system of FIG. 1 advantageously provides automated interconnection between credentialing, privileging and workload management functions. In contrast, existing systems perform patient acuity assessment, but offer limited automated integration with individual patient care processes, and with physicians and other clinicians to increase their efficiency in providing required care.

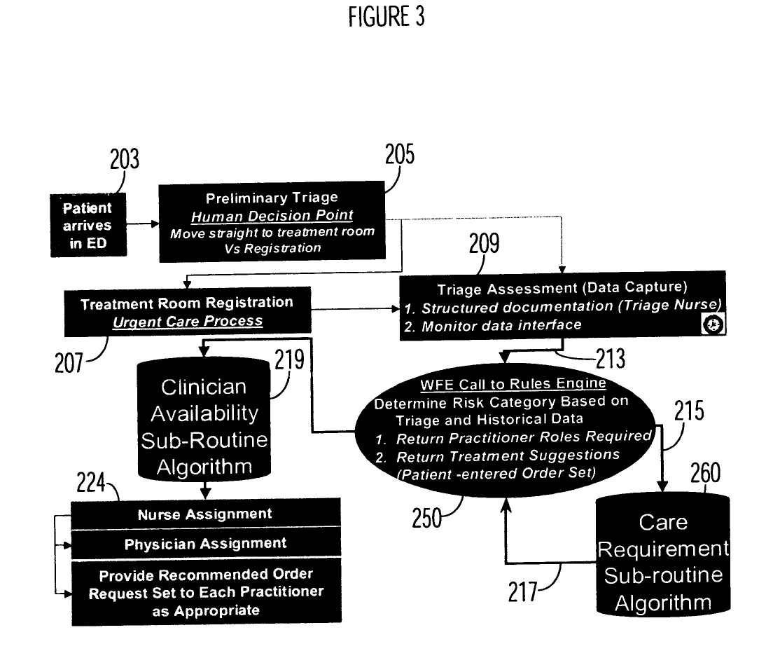

FIG. 3 shows a process and data flow for automated task assignment and clinical load balancing employed by the system of FIG. 1. In exemplary operation, in step 203 a 76 year old female patient arrives at an Emergency Department with a hip fracture identified by a triage nurse in step 205 based on the patient's history, discomfort and a quick examination showing internal rotation of the leg at the hip. A treatment and room allocation emergency registration process is performed in step 207. Further evaluation in step 209 involves a cardiac monitor interface indicating complete heart block with an accelerated junctional rhythm. It also determines blood pressure from the automatic sphygmomanometer interface is low at 92/40 and there is a prior history of hypertension controlled by medication (lisinopril). Completion of the triage assessment in step 209 involves data acquisition including data entry (in both structured and free text form) by a triage nurse and input from monitor devices (cardiac and blood pressure devices). Acquisition of the information in step 209 triggers workflow Engine (WFE) 250 in step 213 to execute predetermined rules to add relevant historical information (e.g., a prior history of myocardial infarction) to the acquired information. The acquired information is provided by a Care Requirement Subroutine Function 260 in step 215.

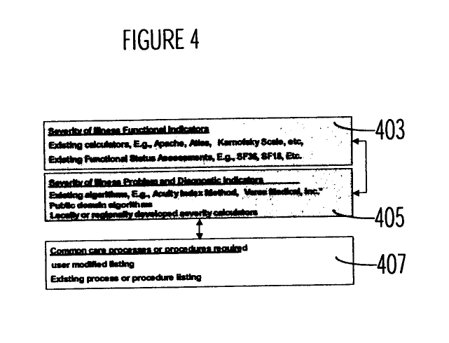

FIG. 4 shows a process employed by the Care Requirement Subroutine Function 260 (FIG. 3) of application 100 for determining services (and their priority) required by a patient. The Care Requirement Subroutine Function 260 in step 403 adjusts a severity of illness identifier using existing or newly developed acuity and severity indexes and calculators based on functional indicators (from the acquired information including data entered during the triage and monitor device data). In step 405, the Care Requirement Subroutine Function 260 advantageously also adjusts the severity of illness identifier based on problem or diagnostic indicators. Diagnostic indicators in this example include (but are not limited to), acute presence of complete heart block with junctional rhythm, hypotension, likely related to heart block, with additional potential differential diagnoses and acute hip fracture. Trauma and osteoporosis is the likely cause with other causes of bone disease or metastases in the differential diagnosis.

In step 407, the Care Requirement Subroutine Function 260 uses the severity of illness identifier derived in steps 403 and 405 together with medical process and procedure listings to predict an overall intensity of service required for the care of the patient. In this example these include (but are not limited to): the management of fluid balance, blood pressure and heart rate; an evaluation for medication alteration and pacemaker (temporary or permanent) based on heart blockage and prior myocardial infarction prior to surgical intervention for hip fracture; an evaluation of hip fracture for cause and most effective stabilization and treatment; and the management for prevention of deep vein thrombosis and pulmonary embolus.

Returning to the process of FIG. 3, the results provided by the Care Requirement Subroutine Function 260 of application 100 (FIG. 1) are returned to the workflow Engine (WFE) 250 in step 217 (FIG. 3). Workflow Engine (WFE) 250 identifies available clinicians able to meet the patient care requirements determined by function 260. For this purpose function 260 provides Workflow Engine 250 with data indicating physician and clinician roles required as well as treatment suggestions such as a treatment order set. Workflow Engine (WFE) 250 initiates execution of Clinician Availability Subroutine Function 219.

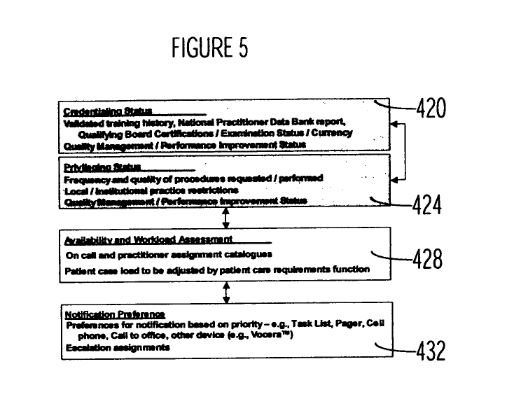

FIG. 5 shows a process employed by Clinician Availability Subroutine Function 219 of application 100 for determining clinician availability and suitability for delivering services required by a patient. The Clinician Availability Subroutine Function 219 in steps 420 and 424 uses a credentialing status library to identify those clinicians with qualified training and credentials (board certification, qualifications, successful performance improvement status) to meet the needs of the patient care requirements derived by function 260. In existing systems, credentialing status of physicians is typically retained in a different department (e.g., Medical Staff Department) than credentialing status of clinicians (e.g., in Nursing and other departments and/or Human Resources). In contrast, function 219 in steps 420 and 424 determines credential and privilege status data of healthcare workers for real-time use in patient care assignments. Specifically, in this example, function 219 identifies workers to meet the needs of the patient care requirements derived by function 260 including, a Cardiologist with privileges for temporary pacemaker insertion, an Orthopedic physician with specialty in hip fracture procedures, an Orthopedic nurse practitioner with joint repair and replacement care privileges, a Cardiology nurse practitioner and a Physical therapist with combined cardiac and orthopedic rehabilitation experience privileges.

Function 219 in steps 420 and 424 identifies those appropriately credentialed clinicians with privileges in the facility to perform expected procedures to meet the needs of the patient care requirements derived by function 260. US Regulators (e.g., JCAHO) require medical staff sections of hospitals to maintain privileging allowances for each physician for each function requested by the physician. Function 219 adjusts privilege information to take into account the frequency with which an individual procedure is performed by a particular individual physician and the quality with which the individual procedure is performed (as a result, stored privilege information incorporates performance related data improvement used for performance derived by quality control data review and analysis). Function 219 identifies healthcare workers for performing the role of Cardiologist with privileges for temporary pacemaker insertion. The workers include, for example, Drs. A. Arterial, A. Atrial and A. Ventricular in a first Cardiology group (3 of the 10 physicians in the first group) as well as Drs. B. Tricuspid, B. Aortic, and B. Mitral in a second Cardiology group (3 of the 4 physicians in the second group) and Dr. C. Chordae, a solo practitioner in Cardiology.

The identified healthcare workers for performing the role of Orthopedic physician with specialty in hip fracture procedures include, for example, Drs. A. Capsule, A. Femoral and A. Trochanter in a first Orthopedic group (3 of the 14 physicians in the first group) as well as Drs. B. Iliac, B. Bursa, and B. Quadricep in a second Orthopedic group (3 of the 9 physicians in the second group) and Dr. C. Fibula, a solo practitioner in Orthopedics. The identified healthcare workers for performing the role of Orthopedic nurse practitioner with joint repair and replacement care privileges include, for example, Nurse Woundeare, Nurse Fixit, Nurse Walker and Nurse Cane. The identified healthcare workers for performing the role of Cardiology nurse practitioner include, for example, Nurse Heart, Nurse Fraction, Nurse Pressure and Nurse Diastolic. The identified healthcare workers for performing the role of Physical therapist with combined cardiac and orthopedic rehabilitation experience privileges include, for example, Mr. Ambulate, Ms. Thrombosis and Ms. Trapeze.

Function 219 in step 428 advantageously determines available clinicians for performing expected procedures to meet the needs of the patient care requirements derived by function 260 and having appropriate privileges determined in step 424. Function 219 identifies clinicians meeting the patient care requirements and provides a table indicating the current activities of the identified clinicians based on current case load (i.e., indicating an intensity of service “case mix” of existing case load). Further, an individual clinician case load is adjusted based on assignments made to meet the needs of the patient care requirements derived by function 260. The current case load for individual clinicians is determined from on call practitioner assignment schedules and catalogues, for example. Function 219 provides data indicating the most appropriate clinicians for providing the patient care requirements based on probability of an individual clinician being able to manage the patient in an efficient time frame. The data indicating appropriate clinicians is automatically used to assign clinician tasks for the patient. In another embodiment, the data indicating appropriate clinicians may be further managed or edited by a management level clinician prior to assignment of clinician tasks.

Function 219 provides data indicating availability of the most appropriate clinicians for performing the role of Cardiologist with privileges for temporary pacemaker insertion. The data indicates, for example, Dr. C. Chordae a solo practitioner in Cardiology is on call but in process of the first of 4 procedures with expected availability in 2.5 hours. Dr. Ace Inhibitor in a second Cardiology physician group is on call for the group, but not privileged for pacemaker insertion and therefore is deemed unavailable. Dr. B. Mitral in the second Cardiology physician group is selected by function 219 based on availability. The data indicating availability of the most appropriate clinicians for performing the role of orthopedic physician with specialty in hip fracture procedures, for example, indicates Dr. R. Scapula in a first Orthopedic physician group is on call and privileged for hip procedures, for emergencies, but has performed only one procedure in the past year. Further, Drs. A. Femoral and A. Capsule in the first Orthopedic physician group are each in the operating room without availability for approximately four hours. Function 219 selects Dr. A. Trochanter for the new Emergency Department patient because he is available and has appropriate privileges.

Function 219 provides data indicating availability of the most appropriate clinicians for performing the role of Orthopedic nurse practitioner with joint repair and replacement care privileges. The data indicates, for example, Nurse Woundcare is on vacation and nurse Fixit is assigned to outpatient rehabilitation for the month and is unavailable. Further, the data indicates nurse Walker is caring for 34 patients with a high intensity of service level including 10 patients requiring discharge management today. Nurse Cane is caring for 25 patients with a moderate intensity of service level with 2 requiring discharge management today. Function 219 selects Nurse Cane for the new Emergency Department patient.

Function 219 also provides data indicating availability of the most appropriate clinicians for performing the role of Orthopedic nurse practitioner. The data indicates, for example, nurse Heart is caring for 24 inpatients including 8 of Dr. Chordae's patients that require discharge management today. The data indicates, Nurse Diastolic has not responded to the last 5 urgent requests and notifications have been escalated to her supervisor and her tasks reassigned. The data also indicates nurse Fraction is assisting in a cardiac catheterization laboratory for 7 scheduled cases and 2 emergency cases today and nurse Pressure is caring for 15 inpatients following the discharge 7 patients this morning. Function 219 selects nurse Pressure for the new Emergency Department patient.

Function 219 also provides data indicating availability of the most appropriate clinicians for performing the role of Physical therapist with combined cardiac and orthopedic rehabilitation experience privileges. The data indicates, for example, Mr. Ambulate has been assigned 14 inpatients with high intensity therapy requirements and 7 outpatients to be treated with moderate therapy requirements. Further, the data indicates Ms. Thrombosis has been assigned 10 inpatients with moderate intensity therapy requirements and has no outpatients scheduled and Ms. Trapeze has been assigned 15 high intensity inpatients and has 10 outpatients scheduled for treatment. The three therapists have privileges in the areas required, but due to his greater experience, function 219 assigns Mr. Ambulate to the new Emergency Department patient and reassigns 7 of Mr. Ambulate's inpatients to Ms. Thrombosis to balance his case load for the day.

Function 219 in step 432 notifies the selected clinicians of tasks to be performed to meet the needs of the patient care requirements derived by function 260. Function 219 notifies the selected clinicians via communication links established based on data derived from one or more predetermined notification preference tables. The preference data identifies preferred communication methods and associated information (including protocol, data format, addresses, phone/fax/pager numbers, email addresses) supporting communication on respective links. A notification preference table includes data identifying and supporting communication via links preferred by at least one of, an individual clinician, a hospital department or other group. A notification preference table includes notification preferences based on urgency (e.g., stat, urgent, now, routine).

Returning to the process of FIG. 3, in step 224 recommended order request sets are provided to respective clinicians notified by Function 219. The assigned tasks that are not completed in expected time frames are escalated back to the assigned clinician and/or a management level clinician. The system automatically re-assigns non-completed tasks to a new clinician in response to predetermined time limit thresholds being exceeded, or in another embodiment, are re-assigned by a management level clinician. This completes the process of FIG. 3.

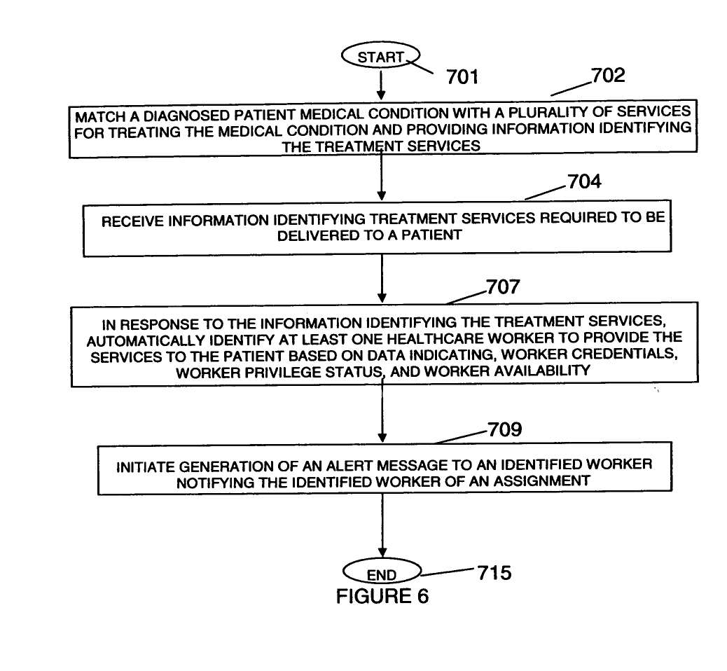

FIG. 6 shows a flowchart of a process employed by application 100 (FIG. 1) for automated task assignment and clinical load balancing. Machine readable instructions for executing the process may be embodied in a tangible storage medium. Application 100 in step 702 following the start at step 701, identifies an intensity (e.g., urgency or severity) level of a diagnosed patient medical condition and matches the intensity level of the diagnosed patient medical condition with a plurality of services for treating the medical condition of the identified intensity. In step 704, application 100 receives information identifying the treatment services required to be delivered to a patient. In step 707 application 100 in response to the information identifying the treatment services, automatically identifies at least one healthcare worker to provide the services to the patient based on data indicating, worker credentials, worker privilege status, and worker availability. Application 100 does this by using worker credentials, worker privilege status and worker availability in determining a probabilistic estimate of likelihood a worker is able to provide the services in an acceptable time frame. The worker credentials include, a regulatory license to practice medicine, a practitioner database report, a validated training history, board certification, an examination status, a performance improvement status or a quality rating.

The worker privilege status is determined based on at least one of, a number of times a worker has performed a particular service, a frequency a worker has performed a particular service or procedure and an associated clinical success outcome indicator as well as dates a worker has performed a particular service. The worker privilege status is also determined based on at least one of, an estimated quality rating of services performed by a worker, regulatory medicine practice restrictions, hospital medicine practice restrictions and performance improvement status. The worker availability is determined based on a predetermined worker work schedule. Application 100 in step 709 (or a separate scheduling application in another embodiment) schedules an identified healthcare worker to provide a service to the patient and initiates generation of an alert message to an identified worker notifying the identified worker of an assignment involved in providing an identified treatment service required to be delivered to the patient. The process of FIG. 6 ends at step 715.

FIG. 2 shows a networked hospital information system employing an automated task assignment and clinical load balancing system. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Workflow management system and task schedule unit 42 includes application 100 (FIG. 1) and provides managed load-balancing of assignment of tasks to healthcare workers and supports the processes of FIG. 2-5. In another embodiment unit 42 is located in client device 12. User interface system 40 (which may also reside in client device 12) includes an input device that permits a user to provide information to client device 12 and an output device that provides a user a display of the multi-row tabbed menus and other information. Preferably, the input device is a keyboard and mouse, but also may be a touch screen or a microphone with a voice recognition program, or a telephone voice response system for example. The output device is a display, but also may be a speaker, for example. The output device provides information to the user responsive to the input device receiving information from the user or responsive to other activity by client device 12. For example, the display presents information responsive to the user entering information in the client device 12 via a keyboard.

Server device 18 includes processor 30, a memory unit 32 including workflow data and a treatment plan 36 and a database 38 containing patient records. Unit 42 matches an identified intensity level of a diagnosed patient medical condition with a plurality of services for treating the medical condition of the identified intensity and storage in plan 36. Unit 42, in response to information identifying treatment services required by a patient, automatically identifies at least one healthcare worker to provide the services to the patient based on data indicating, worker credentials, worker privilege status, and worker availability. Server device 18 may be implemented as a personal computer or a workstation. Database 38 provides a location for storing patient records and data storage unit 14 provides an alternate store for patient records, as well as other information for hospital information system 10. The information in data storage unit 14 and database 38 is accessed by multiple users from multiple client devices. Alternatively, patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The first local area network (LAN) 16 (FIG. 2) provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 2, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

Departmental systems 22 are systems that need access to information or provide information related to the health and/or welfare of patients in the care of the healthcare provider. Examples of the departmental systems 22 include, a lab system 44, a pharmacy system 46, a financial system 48 and a nursing system 50, as shown in FIG. 2, but may also include a records system, a radiology system, an accounting system, a billing system, and any other system required or desired in a healthcare information system.

The system, processes and user interface menus presented in FIGS. 1-6 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems of FIGS. 1 and 2 and processes of FIGS. 3-6 may be implemented in hardware, software or a combination of both. The system is usable wherever an available worker having particular credentials or privileges, needs to be identified to provide services.

What is claimed is:

1. A system for assigning patient treatment related tasks to healthcare workers, comprising:
an interface processor for receiving information identifying treatment services required to be delivered to a patient;
a worker assignment processor for, in response to said information identifying said treatment services, automatically identifying at least one healthcare worker to provide said services to said patient based on data indicating,
worker credentials,
worker privilege status, and
worker availability; and
a communication processor for initiating generation of an alert message to an identified worker notifying said identified worker of an assignment.

2. A system according to claim 1, wherein
said worker credentials include at least one of, (a) a regulatory license to practice medicine, (b) a practitioner database report and (c) validated training history.

3. A system according to claim 1, wherein
said worker credentials include at least one of, (a) board certification, and (b) examination status.

4. A system according to claim 1, wherein
said worker credentials include at least one of, (a) performance improvement status and (b) a quality rating.

5. A system according to claim 1, wherein
said worker privilege status is determined by at least one of, (a) a number of times a worker has performed a particular service, (b) a frequency a worker has performed a particular service, (c) dates a worker has performed a particular service and (d) a rated treatment outcome of a particular service performed by a worker.

6. A system according to claim 1, wherein
said worker privilege status is determined by an estimated quality rating of services performed by a worker.

7. A system according to claim 1, wherein
said worker privilege status is determined by at least one of, (a) regulatory medicine practice restrictions, (b) hospital medicine practice restrictions, and (c) performance improvement status.

8. A system according to claim 1, wherein
said worker availability is determined based on a predetermined worker work schedule.

9. A system according to claim 1, wherein
said interface processor identifies treatment services required to be delivered to a patient by matching diagnosed patient medical condition with a plurality of services for treating said medical condition.

10. A system according to claim 9, wherein
said interface processor identifies an intensity level of said diagnosed patient medical condition and matches said intensity level of said diagnosed patient medical condition with a plurality of services for treating said medical condition of said identified intensity.

11. A system according to claim 10, wherein
said intensity comprises at least one of, (a) urgency and (b) severity.

12. A system according to claim 1, including
a task scheduling processor for scheduling said automatically identified at least one healthcare worker to provide said services to said patient.

13. A system according to claim 1, wherein
said worker assignment processor automatically identifies said at least one healthcare worker to provide said services to said patient by using said data indicating said worker credentials, worker privilege status, and worker availability to determine a probabilistic estimate of a likelihood a worker is able to provide said services in an acceptable time frame.

14. A system according to claim 1, wherein
said worker assignment processor automatically identifies at least one healthcare worker to provide said services to said patient based on worker competency data including at least one of, (a) a frequency with which a healthcare worker performs a particular task or procedure and (b) an associated clinical success outcome indicator.

15. A system for assigning patient treatment related tasks to healthcare workers, comprising:
an interface processor for matching a diagnosed patient medical condition with a plurality of services for treating said medical condition and providing information identifying said treatment services;
a worker assignment processor for, in response to said information identifying said treatment services, automatically identifying at least one healthcare worker to provide said services to said patient based on data indicating,
worker credentials,
worker privilege status, and
worker availability; and
a communication processor for initiating generation of an alert message to an identified worker notifying said identified worker of an assignment.

16. A system according to claim 15, wherein
said interface processor identifies an intensity level of said diagnosed patient medical condition and matches said intensity level of said diagnosed patient medical condition with said plurality of services for treating said medical condition of said identified intensity.

17. A system according to claim 16, wherein
said intensity comprises at least one of, (a) urgency and (b) severity.

18. A method for assigning patient treatment related tasks to healthcare workers, comprising the activities of:
receiving information identifying treatment services required to be delivered to a patient;
in response to said information identifying said treatment services,
automatically identifying at least one healthcare worker to provide said services to said patient based on data indicating,
worker credentials,
worker privilege status, and
worker availability; and
initiating generation of an alert message to an identified worker notifying said identified worker of an assignment.

19. A tangible storage medium incorporating machine readable instructions for executing said method of claim 18.
